(19) United States
(12) Patent Application Publication
(10) Pub. No.: US 2026/0128822 A1
(43) Pub. Date: May 7, 2026

(54) TAG-BASED SELECTIVE PACKET DUPLICATION

(71) Applicant: Cisco Technology, Inc., San Jose, CA (US)

(72) Inventors: Abhinesh Mishra, Bangalore (IN); Saurabh Srivastava, Bangalore (IN); Shishir Kumar, Bangalore (IN); Manikandan Thiyagarajakumar, Bangalore (IN)

(21) Appl. No.: 18/939,169

(22) Filed: Nov. 6, 2024

(51) Int. Cl. H04L 1/1867; H04L 9/40; H04L 61/5014; H04L 69/22

(52) U.S. Cl. CPC H04L 1/189; H04L 61/5014; H04L 63/08; H04L 63/104; H04L 69/22

(57) ABSTRACT

Disclosed is technology for selectively determining whether to duplicate a packet based on factors beyond just the application it is associated with. For example, some methods determine a criticality of the packet by reading a tag stored in a header of the packet. The tag can represent a group to which the user is associated with, e.g., the financial department, and assign a criticality score based on that group and in some cases other factors. The criticality score can be measured against a threshold to determine whether duplication should occur in the next hop. The method therefore selectively determines whether to duplicate a packet, thereby avoiding costly overduplication, while also placing this tag in a header of the packet, which can be read easily and without deep packet inspection.

### TECHNICAL FIELD

The present disclosure relates to network communication, and in particular to performing selective packet duplication based on tags.

### BACKGROUND

Reliable transmission of data packets is a focus for mission-critical applications such as financial transactions, healthcare monitoring, and real-time communication. These applications demand high availability and minimal downtime, where any packet loss or delay could result in significant disruptions. As a common approach, network architects often employ tunneling protocols that encapsulate and securely transmit data across networks. To enhance reliability, packet duplication is applied within these tunnels, where multiple copies of the same packet are sent to ensure that at least one copy reaches the destination.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example of a high-level network architecture in accordance with at least some embodiments of the present technology.

FIG. 2 illustrates an example communication network including one or more autonomous systems (ASes) in accordance with at least some embodiments of the present technology.

FIG. 3 illustrates a schematic diagram of a packet duplication method in accordance with at least some embodiments of the present technology.

FIG. 4 illustrates a schematic diagram of a packet duplication system in accordance with at least some embodiments of the present technology.

FIG. 5 illustrates a schematic diagram of an exemplary system architecture to be used with selective duplication methods in accordance with at least some embodiments of the present technology.

FIG. 6 illustrates a routine for selective packet duplication in accordance with at least some embodiments of the present technology.

FIG. 7 shows an example of a system for implementing certain aspects of the present technology.

### DETAILED DESCRIPTION OF EXEMPLARY EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Peter Drucker once said “Efficiency is doing things right; effectiveness is doing the right things. Don't duplicate efforts, duplicate results.” This is true in packet duplication within software defined wide area networks (SD-WAN). Many SD-WANs duplicate streams of packets sent from a wide area network (WAN) edge router over multiple tunnels to the next hop router. If a packet is lost over the network, the receiving router uses a copy of the lost packet received through other tunnels. If no packet is lost, the duplicate packet is discarded. This process creates a “backup” packet that travels from the same source to the same destination, increasing the probability of effective packet transmission even in the event of packet loss.

Packet duplication is, of course, inefficient. Transmitting two packets instead of one necessarily requires additional tunnels and computational expense. It is worth the expense for some applications that are mission-critical but can be too burdensome to implement for every packet transmitted from one router to another. Further, whether to duplicate the packet is determined through deep packet inspection (DPI) which is itself computationally expensive.

The presently disclosed embodiments include a method for selectively determining whether to duplicate a packet based on factors beyond just the application it is associated with. For example, some methods determine a criticality of the packet by reading a tag stored in a header of the packet. The tag can represent a group to which the user is associated with, e.g., the financial department, and assign a criticality score based on that group and in some cases other factors. The criticality score can be measured against a threshold to determine whether duplication should occur in the next hop. The method therefore selectively determines whether to duplicate a packet, thereby avoiding costly overduplication, while also placing this tag in a header of the packet, which can be read easily and without deep packet inspection.

The presently disclosed embodiments include a method, network device, and computer-readable medium that perform various steps. The steps include determining, by the network device, a group to which a user is associated; receiving a data packet; attaching a tag to a header of the data packet representing a user criticality score that quantifies a criticality of the group to which the user is associated; computing an overall criticality score based at least in part on the user criticality score; and determining whether to duplicate the data packet based on the overall criticality score.

In some embodiments, the technology includes inspecting the data packet to determine an application to which the data packet is associated.

In some embodiments, the technology includes determining an application criticality score based on the application to which the data packet is associated; and computing the overall criticality score based at least in part on the user criticality score and the application criticality score.

In some embodiments, determining whether to duplicate the data packet is performed by comparing the overall criticality score to a threshold score.

In some embodiments, the technology includes receiving the threshold score from an administrator of a network.

In some embodiments, the group to which the user is associated is determined by authenticating the user; determining an internet protocol address (IP address) of the user; and determining the group to which the user is associated based on the IP address of the user.

In some embodiments, the IP address is determined by retrieving the IP address from at least one of a dynamic host configuration protocol pool (DHCP pool) and static allocation.

In some embodiments, determining whether to duplicate the data packet is performed by comparing the overall criticality score against a range of criticality scores, and duplicating the data packet only if the overall criticality score is within the range of criticality scores.

### Example Embodiments

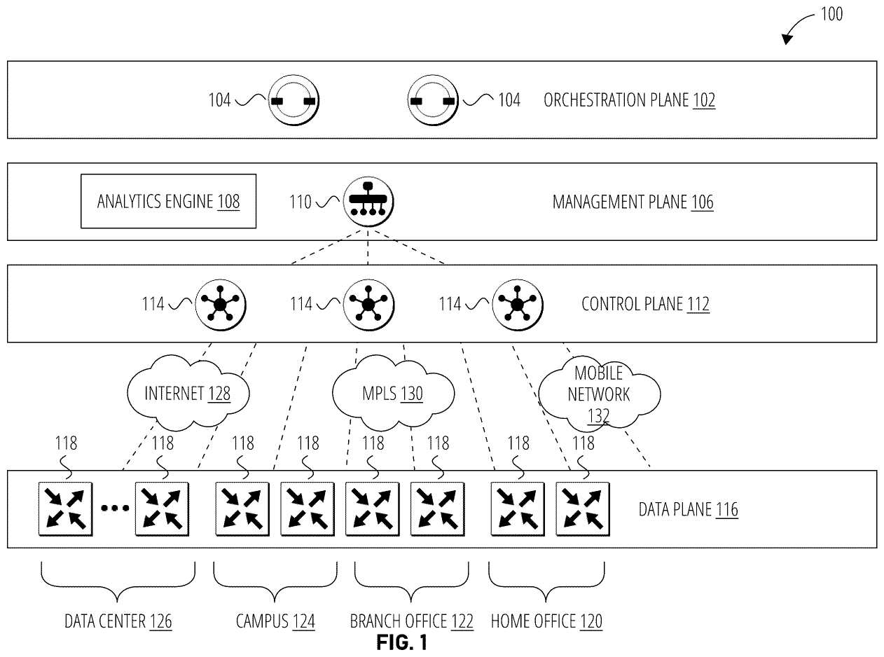

FIG. 1 illustrates an example of a network architecture 100 for implementing aspects of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 106, a control plane 112, and a data plane 116. The orchestration plane 102 can assist in the automatic on-boarding of edge network devices 118 (e.g., switches, routers, etc.) in an overlay network. The orchestration plane 102 can include one or more physical or virtual network orchestrator appliances 104. The network orchestrator appliances 104 can perform the initial authentication of the edge network devices 118 and orchestrate connectivity between devices of the control plane 112 and the data plane 116. In some embodiments, the network orchestrator appliances 104 can also enable communication of devices located behind Network Address Translation (NAT). In some embodiments, physical or virtual Cisco® SD-WAN vBond appliances can operate as the network orchestrator appliances 104.

The management plane 106 can be responsible for central configuration and monitoring of a network. The management plane 106 can include one or more physical or virtual network management appliances 110. In some embodiments, the network management appliances 110 can provide centralized management of the network via a graphical user interface to enable a user to monitor, configure, and maintain the edge network devices 118 and links (e.g., internet transport network 128, MPLS network 130, 4G/Mobile network 132) in an underlay and overlay network. The network management appliances 110 can support multi-tenancy and enable centralized management of logically isolated networks associated with different entities (e.g., enterprises, divisions within enterprises, groups within divisions, etc.). Alternatively or in addition, the network management appliances 110 can be a dedicated network management system for a single entity. In some embodiments, physical or virtual Cisco® SD-WAN vManage appliances can operate as the network management appliances 110. The management plane 106 can further include an analytics engine 108, as is known in the art.

The control plane 112 can build and maintain a network topology and make decisions on where traffic flows. The control plane 112 can include one or more physical or virtual network control appliances 114. The network control appliances 114 can establish secure connections to each edge network device 118 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network control appliances 114 can operate as route reflectors. The network control appliances 114 can also orchestrate secure connectivity in the data plane 116 between and among the edge network devices 118. For example, in some embodiments, the network control appliances 114 can distribute crypto key information among the edge network devices 118. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network control appliances 114.

The data plane 116 can be responsible for forwarding packets based on decisions from the control plane 112. The data plane 116 can include the edge network devices 118, which can be physical or virtual edge network devices. The edge network devices 118 can operate at the edges various network environments of an organization, such as in one or more data centers 126, campus networks 124, branch office networks 122, home office networks 120, and so forth, or in the cloud (e.g., Infrastructure as a Service (IaaS), Platform as a Service (PaaS), SaaS, and other cloud service provider networks). The data plane 116 also runs features like DPI, packet duplication, and other features provisioned from the management plane 106 and routes based on decision from the control plane 112. The edge network devices 118 can provide secure data plane connectivity among sites over one or more WAN transports, such as via one or more internet transport networks 128 (e.g., Digital Subscriber Line (DSL), cable, etc.), MPLS networks 130 (or other private packet-switched network (e.g., Metro Ethernet, Frame Relay, Asynchronous Transfer Mode (ATM), etc.), mobile networks 132 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 118 can be responsible for traffic forwarding, security, encryption, quality of service (QoS), and routing (e.g., BGP, OSPF, etc.), among other tasks. In some embodiments, physical or virtual Cisco® SD-WAN vEdge routers can operate as the edge network devices 118.

A computer network is a geographically distributed collection of nodes interconnected by communication links and segments for transporting data between end nodes, such as personal computers and workstations, or other network devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other.

Since management of interconnected computer networks can prove burdensome, smaller groups of computer networks may be maintained as routing domains or autonomous systems. An Autonomous System (AS) is a network or group of networks under common administration and with common routing policies. A typical example of an AS is a network administered and maintained by an Internet Service Provider (ISP). Customer networks, such as universities or corporations, connect to the ISP, and the ISP routes the network traffic originating from the customer networks to network destinations that may be in the same ISP or may be reachable only through other ISPs.

To facilitate the routing of network traffic through one or more ASes, the network elements of the ASes need to exchange routing information to various network destinations. Border Gateway Protocol (BGP) is an Exterior Gateway Protocol (EGP) that is used to exchange routing information among network elements (e.g., routers) in the same or different ASes. A computer host that executes a BGP process is typically referred to as a BGP host or a BGP network device. To exchange BGP routing information, two BGP hosts, or peers, first establish a transport protocol connection with one another. Initially, the BGP peers exchange messages to open a BGP session, and, after the BGP session is open, the BGP peers exchange their entire routing information. Thereafter, only updates or changes to the routing information are exchanged, or advertised, between the BGP peers. The exchanged routing information is maintained by the BGP peers during the existence of the BGP session.

The networks within an AS are typically coupled together by conventional “intradomain” routers configured to execute intradomain routing protocols, and are generally subject to a common authority. To improve routing scalability, a service provider (e.g., an ISP) may divide an AS into multiple “areas” or “levels.” It may be desirable, however, to increase the number of nodes capable of exchanging data; in this case, interdomain routers executing interdomain routing protocols are used to interconnect nodes of the various ASes. Moreover, it may be desirable to interconnect various ASes that operate under different administrative domains. As used herein, an AS, area, or level is generally referred to as a “domain.”

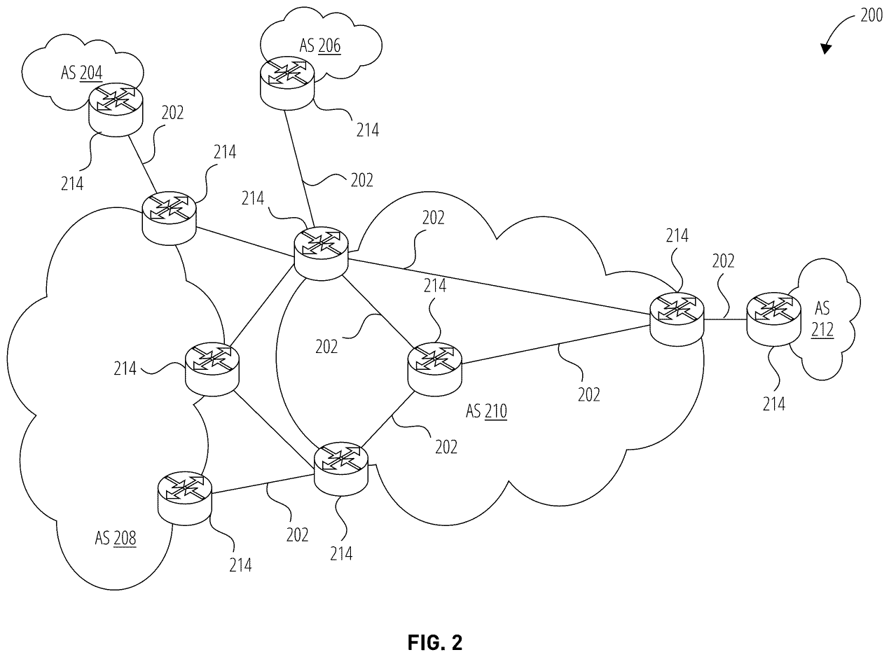

FIG. 2 is a schematic block diagram of an example computer network 200 illustratively comprising network devices 214 interconnected by various methods of communication. For instance, the communication paths 202 may be any suitable combination of wired links and shared media (e.g., wireless links, Internet Exchange Points, etc.) where certain network devices 214, such as, e.g., routers, computers, etc., may be in communication with other network devices 214, e.g., based on distance, signal strength, current operational status, location, etc. Those skilled in the art will understand that any number of network devices 214, links, etc. may be used in the computer network, and that the view shown herein is for simplicity.

Data packets (e.g., traffic and/or messages sent between the network devices 214) may be exchanged among the network devices 214 of the computer network 200 using predefined network communication protocols such as certain known wired protocols, as well as wireless protocols or other shared-media protocols where appropriate.

The computer network 200 includes a set of autonomous systems (AS) labeled as AS 204, AS 206, AS 208, AS 210 and AS 212. The computer network 200 may be positioned in any suitable network environment or communications architecture that operates to manage or otherwise direct information using any appropriate routing protocol or data management standard. For example, computer network 200 may be provided in conjunction with a border gateway protocol (BGP).

As noted above, an AS may be a collection of connected Internet Protocol (IP) routing network devices 214 under the control of one or more network operators that presents a common, clearly defined routing policy to a network (e.g., the Internet). Usually, an AS comprises network devices 214 that are established on the edge of the system, and that serve as the system's ingress and egress points for network traffic. Moreover, the network devices 214 may be considered edge network devices, border routers, or core network devices within the respective AS. These network devices typically, but not always, are routers or any other element of network infrastructure suitable for switching or forwarding data packets according to a routing protocol or switching protocol. For the purposes of the present disclosure, the network devices 214 located within an AS may alternatively be referred to as “forwarding network devices” or “intermediate network devices.” Moreover, for illustration purposes, the AS 204, AS 206, AS 208, AS 210, and AS 212 are shown with a limited number of network devices 214. In an actual implementation, however, an AS normally comprises numerous routers, switches, and other elements.

Each AS 204, AS 206, AS 208, AS 210, and AS 212 may be associated with an Internet Service provider (ISP). Even though there may be multiple ASes supported by a single ISP, the Internet only sees the routing policy of the ISP. That ISP must have an officially registered Autonomous System Number (ASN). As such, a unique ASN is allocated to each AS for use in BGP routing. ASNs are important primarily because they uniquely identify each network on the Internet.

To facilitate the routing of network traffic through the ASes, or more specifically, the network devices 214 within the ASes, the network devices may exchange routing information to various network destinations. As described above, BGP is conventionally used to exchange routing and reachability information among network devices 214 within a single AS or between different ASes. One particular example of BGP is BGPv4, as defined in Request for Comments (RFC) 1771 of the Internet Engineering Task Force (IETF). Various embodiments may implement other versions of BGP, however, and the use of BGPv4 is not required. The BGP logic of a router is used by the data collectors to collect BGP AS path information, e.g., the “AS_PATH” attribute, as described further below, from BGP tables of border routers of an AS, to construct paths to prefixes.

To exchange BGP routing information, two BGP hosts (network devices 214), or peers, first establish a transport protocol connection with one another. Initially, the BGP peers exchange messages to open a BGP session, and, after the BGP session is open, the BGP peers exchange their entire routing information. Thereafter, in certain embodiments, only updates or changes to the routing information, e.g., the “BGP UPDATE” attribute, are exchanged, or advertised, between the BGP peers. The exchanged routing information is maintained by the BGP peers during the existence of the BGP session.

The BGP routing information may include the complete route to each network destination, e.g., “destination network device,” that is reachable from a BGP host. A route, or path, comprises an address destination, which is usually represented by an address prefix (also referred to as prefix), and information that describe the path to the address destination. The address prefix may be expressed as a combination of a network address and a mask that indicates how many bits of the address are used to identify the network portion of the address. In Internet Protocol version 4 (IPv4) addressing, for example, the address prefix can be expressed as “9.2.0.2/16”. The “/16” indicates that the first 16 bits are used to identify the unique network leaving the remaining bits in the address to identify the specific hosts within this network.

A path joining a plurality of ASes, e.g., communication paths 202, may be referred to as an “AS_PATH.” The AS_PATH attribute indicates the list of ASes that must be traversed to reach the address destination. For example, as illustrated in FIG. 2, the AS 212 may store an AS_PATH attribute of “204 206 210 212” where the address destination is the AS 212 (or a particular IP address within AS 212). Here, the AS_PATH attribute indicates that the path to the address destination AS 212 from AS 208 passes through AS 204, AS 206 and AS 210, in that order.

Although it may be preferable that all network devices 214 in AS 204, AS 206, AS 208, AS 210, and AS 212 be configured according to BGP, in a real-world implementation, it may be unlikely that each network device communicates using BGP. Thus, the disclosed embodiments are applicable to scenarios where all network devices 214 in the computer network 200 are configured according to BGP, as well as scenarios where only a subset of the network devices 214 is configured as such. Moreover, between any of the ASes, there may be a single communication path 202, e.g., between AS 204 and AS 208, as shown in FIG. 2, or there may be multiple communication paths 202, e.g., between AS 208 and AS 210. Thus, the disclosed embodiments are applicable to either case, as described in further detail below.

Moreover, a security extension to the BGP has been developed, referred to as BGPSEC, which provides improved security for BGP routing. BGP does not include mechanisms that allow an AS to verify the legitimacy and authenticity of BGP route advertisements. The Resource Public Key Infrastructure (RPKI) provides a first step towards addressing the validation of BGP routing data. BGPSEC extends the RPKI by adding an additional type of certificate, referred to as a BGPSEC router certificate, that binds an AS number to a public signature verification key, the corresponding private key of which is held by one or more BGP speakers within this AS. Private keys corresponding to public keys in such certificates can then be used within BGPSEC to enable BGP speakers to sign on behalf of their AS. The certificates thus allow a relying party to verify that a BGPSEC signature was produced by a BGP speaker belonging to a given AS. Thus, a goal of BGPSEC is to use signatures to protect the AS Path attribute of BGP update messages so that a BGP speaker can assess the validity of the AS Path in update messages that it receives. It should be understood, however, that the embodiments for implementing AS Path security disclosed herein are not limited to BGPSEC; certain embodiments may, additionally or alternatively, be applicable to other suitable protocols, including, for example, SoBGP, S-BGP, and PGPBGP, to name just a few.

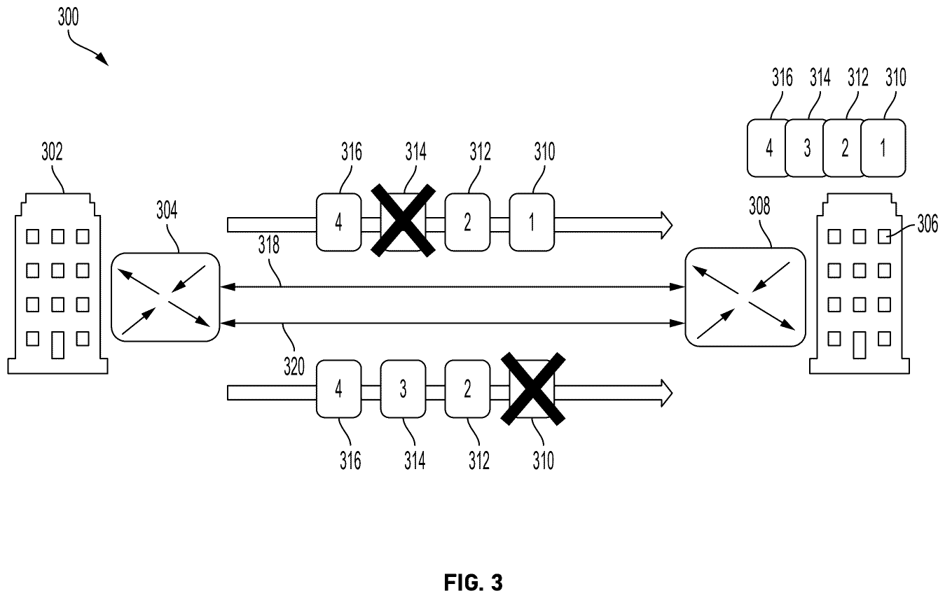

FIG. 3 illustrates a schematic diagram of a packet duplication system in accordance with at least some embodiments of the present technology. As shown, the system 300 includes a branch 302 with a branch edge router 304 communicating with a data center 306 having a data center edge router 308. For example, the branch 302 can communicate a first data packet 310, a second data packet 312, a third data packet 314, and/or a fourth data packet 316, as shown. The data packets can be transmitted across a first tunnel 318 and a second tunnel 320.

As shown in FIG. 3, some of the data packets are lost as they are transmitted from the branch 302 to the data center 306. For example, and as shown with an “X”, the third data packet 314 is lost as it travels through the first tunnel 318 and the first data packet 310 is lost as it travels through the second tunnel 320. However, collectively, the packets passing through the first tunnel 318 and the second tunnel 320 arrive at the data center 306 with one first packet 310, two second packets 312, one third packet 314, and two fourth packets 316. The extra packets (e.g., one second packet 312, and one fourth packet 316) are discarded when they reach the data center 306. In the end, at least one copy of the first data packet 310, the second data packet 312, the third data packet 314, and the fourth data packet 316, safely travel from the branch 302 to the data center 306.

The above method duplicates all packets transmitted from the branch 302 to the data center 306. In doing so, the method significantly improves the likelihood that at least one of each packet will safely arrive at the data center 306. However, the above method is computationally expensive and should be reserved only for mission-critical traffic. The present technology is therefore designed to selectively duplicate data packets, ensuring failover benefits while optimizing efficiency by duplicating only when necessary.

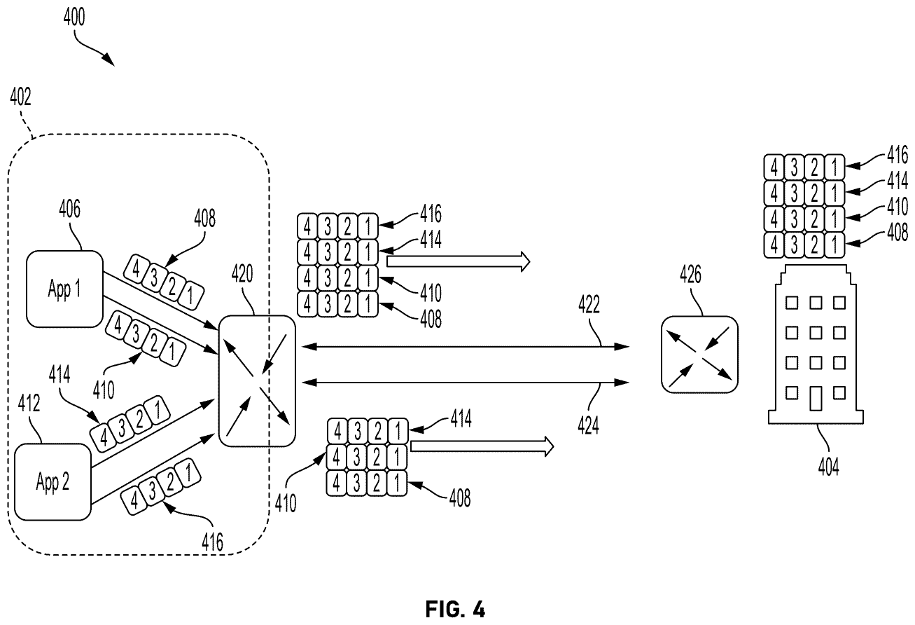

FIG. 4 illustrates a schematic diagram of a packet duplication system in accordance with at least some embodiments of the present technology. As shown, the system 400 includes a branch 402 communicating with a data center 404. The branch 402 includes data packets that are associated with various applications. For example, a first application 406 can include first packets 408 and second packets 410, while a second application 412 can include third packets 414 and fourth packets 416. The first packets 408, second packets 410, third packets 414, and fourth packets 416, can each be transmitted from a branch router 420 across a first tunnel 422 and/or a second tunnel 424 to a data center router 426.

Here, the data packets can be grouped according to both the user for which the packets are associated and also according to the application to which they are associated. For example, packets originating from online banking software are likely to be sensitive and important, therefore requiring duplication. However, packets originating from a social media website are less likely to be important and less likely to be “deserving” of duplication. The disclosed methods and systems can therefore take this importance into account on an application-wide level.

The same is true for the users. A user within the finance group is likely to be transmitting data packets that are critical, therefore suggesting those data packets should be duplicated. However, a less important user may be part of a less important group where the packets are not important enough to justify the computational expense of duplication. Here, the present technology can identify the user among a group of users by reviewing tags in headers of the packets.

One example of such a header and tag system is Cisco(r) TrustSec. TrustSec determines the user or endpoint a packet should be routed to by embedding a Security Group Tag (SGT) in the packet, which is then used in conjunction with network policies to make identity-based routing and access control decisions. TrustSec assigns an SGT to each user or endpoint. The SGT is a unique identifier that reflects the user's or device's security role within the network. SGTs can be assigned based on various factors such as user identity (e.g., from a directory), device type, location, or other attributes. In some embodiments, the SGT represents a group of users who each include the same SGT to identify the criticality of the group.

The SGT is embedded into the packet as it travels through the network. This tag is carried along with the packet as it is routed through TrustSec-enabled devices. The network infrastructure, including switches, routers, and firewalls that support TrustSec, recognizes the SGT and uses it to enforce policies. The policies can be identity-based, meaning they consider the user or device's identity (as represented by the SGT) rather than just the IP address or traditional network attributes.

Of course, other tags can be used as well. The present technology contemplates using user identification tags representing a user criticality score that quantifies a criticality of the group to which the user is associated. For example, the tag can include a user criticality score that reflects the importance of the user within their associated group or the importance of the group within the associated organization or company. This user criticality score could be based on factors such as the user's role, level of responsibility, or the potential impact of their activities on the organization. The tag might also incorporate other relevant identifiers, such as a Department Code (DC) to signify the specific department the user belongs to, or a Risk Level Indicator (RLI) that categorizes the user's risk profile within the system.

As shown, the first packets 408 are associated with the first application 406 and a first user. The second packets 410 are associated with the first application 406 and a second user. The third packets are associated with the second application 412 and the second user. The fourth packets 416 are associated with the second application 412 and the second user. The system 400 can therefore take into account both the user and the application when determining whether to duplicate packets.

As shown, the first packets 408, the second packets 410, the third packets 414, and the fourth packets 416, can be transmitted across the first tunnel 422. The system 400 can assess the criticality of the user and application to determine that the first packets 408, the second packets 410, and the third packets 414 should be duplicated and transmitted across the second tunnel 424. For example, consider the user has a user criticality score of 60 and the application has an application criticality score of 100. Added together, these scores combine to 160. The system may have a duplication threshold of 175, meaning the combined score of 160 is insufficient to warrant duplication. Here, the packets (e.g., the fourth packets 416) would not be duplicated. However, assume the user is a priority user (e.g., the CEO of the company) with a user criticality score of 90, and is transmitting the packets across the same application with an application criticality score of 100. The combined score of 190 would therefore exceed the threshold criticality score of 175 and therefore warrant duplication. This would be the case for, e.g., the third packets 414, which are shown as being duplicated.

As shown above, packets can be assessed based on not only their application but also their user. In doing so, packet duplication can be implemented more selectively to reduce the computational expense associated with duplication. However, the packets that truly need to be duplicated can, in fact, be duplicated and transmitted to provide a failover benefit in the event of packet loss during transit.

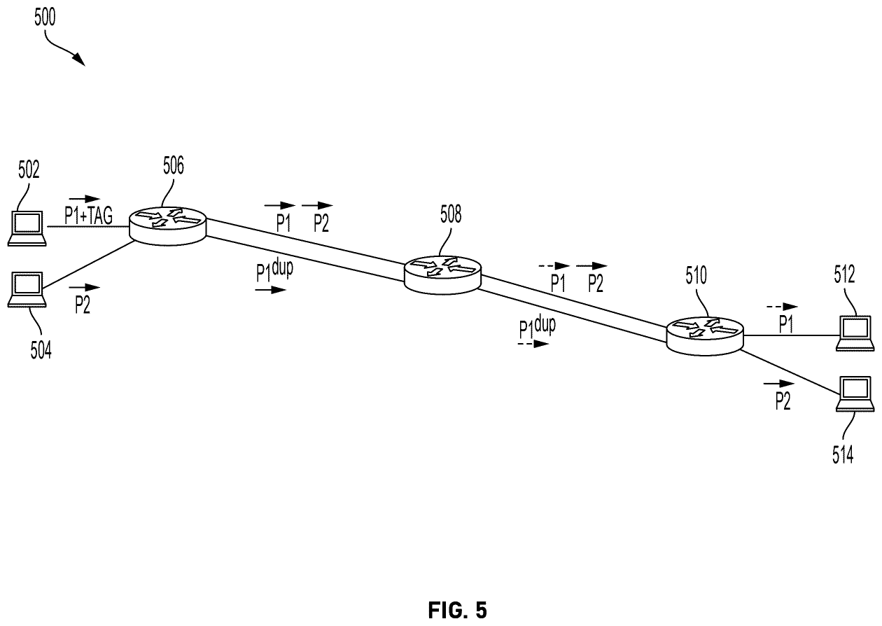

FIG. 5 illustrates a schematic diagram of an exemplary system architecture to be used with selective duplication methods in accordance with at least some embodiments of the present technology. As shown, the system 500 includes a first user 502 and a second user 504 communicably coupled to a first network device 506. The first user 502 can transmit a packet with a tag to the first network device 506, and the second user 504 can transmit an untagged second packet to the first network device 506. In the next hop, the tagged first packet is duplicated by the first network device 506 and transmitted to a second network device 508. For example, the tag may indicate the user or application has an associated criticality score that warrants duplication. The first network device 506 can inspect the tag within the header of the first packet to make the duplication determination.

The packets can then be transmitted to the second network device 508, which acts as an intermediary network device with various applications providing policies and controls. Assume that the first packet P1 is lost in the network from the second network device 508 to a third network device 510. Here, the duplicate labeled P1dup can provide the necessary failover benefit and reach the third network device 510 despite the loss of the other first packet in transit. The third network device 510 can then transmit the packets to a server, for example a finance server 512 or a marketing department server 514.

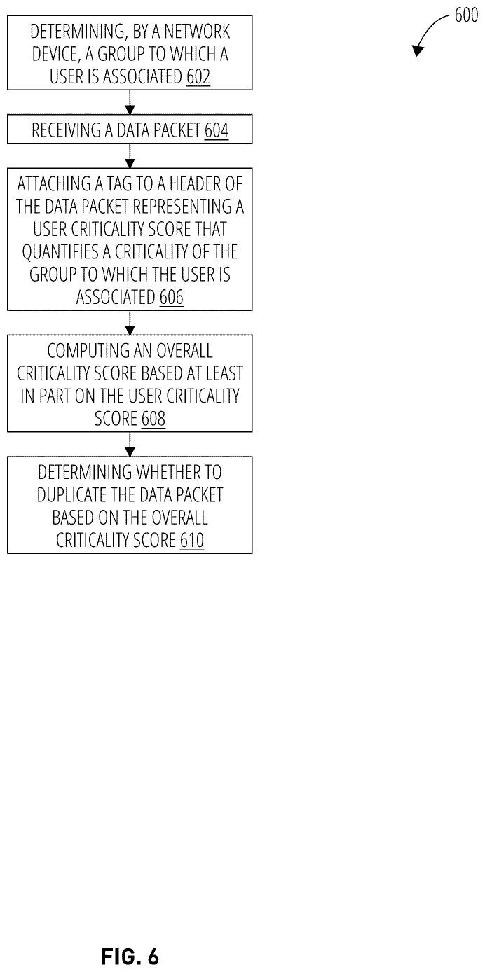

FIG. 6 illustrates a routine for selective packet duplication in accordance with at least some embodiments of the present technology. Although the example routine 600 depicts a particular sequence of operations, the sequence may be altered without departing from the scope of the present disclosure. For example, some of the operations depicted may be performed in parallel or in a different sequence that does not materially affect the function of the routine 600. In other examples, different components of an example device or system that implements the routine 600 may perform functions at substantially the same time or in a specific sequence.

According to some examples, the routine 600 includes determining, by a network device, a group to which a user is associated at box 602. For example, the network devices of FIGS. 3-5 can determine a group to which a user is associated. In some embodiments, the group to which the user is associated is determined by authenticating the user (upon the user connecting to the network, for example), determining an internet protocol address (IP address) of the user, and determining the group to which the user is associated based on the IP address of the user. For example, the IP address can be determined by retrieving the IP address from a dynamic host configuration protocol pool (DHCP pool) or static allocation. In doing so, the network device can compare the IP address against a mapping stored within or accessible to the network device to effectively determine the identity of the user, and the associated group and user criticality score of the user. Doing so allows the routine 600 to assess the criticality of the user rather than only the application to which the data packets are associated.

According to some examples, the routine 600 includes receiving a data packet at block 604. For example, any of the network devices of FIGS. 3-5 can receive the data packet at block 604.

According to some examples, the routine 600 includes attaching a tag to a header of the data packet representing a user criticality score that quantifies a criticality of the group to which the user is associated at block 606. For example, any of the network devices of FIGS. 3-5 can attach a tag to a header of the data packet representing a user criticality score that quantifies a criticality of the group to which the user is associated. This tag can then be carried in the packet to further network devices so that duplication determinations can be made. For example, the determination can be performed by inspecting the header of the packet transmitted to the network device and determining whether a tag is included in the header indicating a user criticality score. The header can be inspected easily since, in some embodiments, it is within the first 20 bytes of the packet, meaning deep packet inspection is not necessary as with prior packet duplication methods.

According to some examples, the method includes computing an overall criticality score based at least in part on the user criticality score at block 608. For example, any of the network devices of FIGS. 3-5 can compute an overall criticality score based at least in part on the user criticality score. For example, the network device can add the user criticality score and the application criticality score to obtain the overall criticality score.

According to some examples, the method includes determining whether to duplicate the data packet based on the overall criticality score at block 610. For example, any of the network devices of FIGS. 3-5 can determine whether to duplicate the data packet based on the overall criticality score. This determination can be made in any manner, for example, by comparing the overall criticality score to a threshold score. For example, an overall criticality score of 165 will not require duplication if the threshold score is 180, in some embodiments. In other embodiments, the threshold score can represent the value the overall criticality score must remain below in order to be duplicated (i.e., the opposite of the above). In other embodiments, determining whether to duplicate the data packet is performed by comparing the overall criticality score against a range of criticality scores, and duplicating the data packet only if the overall criticality score is within the range of criticality scores. The threshold score can be obtained in any way, but in an embodiment, is received from an administrator of a network. For example, the threshold score can be configurable by a controller of the network by an administrator.

In some embodiments, the application to which the data packet is associated can also play a part in the overall criticality score. This can be helpful if a first network device performs packet inspection on the packet to determine the application, and labels the tag with the application criticality score thereafter. Packet inspection can be performed using deep packet inspection, heuristic inspection, or any other packet inspection methodology. Further devices can then retrieve only the tag and avoid deep packet inspection to determine whether to duplicate the packet. For example, this process can include inspecting the data packet to determine an application to which the data packet is associated, determining an application criticality score based on the application to which the data packet is associated, and computing the overall criticality score based at least in part on the user criticality score and the application criticality score. The application criticality score can then be labeled in the tag in the header of the packet.

The routine 600 provides more control to the network administrator by providing the ability to perform targeted packet duplication. This not only preserves costly bandwidth resulting in savings in dollars but also provides for less traffic congestion. It also helps improve the quality of experience for critical users, even in less healthy uplinks.

User criticality scores can be applied to ingress traffic originating from users after authenticating. This can occur through any authentication method, for example, 802.1x (IEEE 802.1X, which is a network access control protocol), MAB (MAC Authentication Bypass), WebAuth (Web Authentication), or other methods such as RADIUS (Remote Authentication Dial-In User Service) or LDAP (Lightweight Directory Access Protocol).

The tags can be applied in any manner, for example manually or by a server. Alternatively, or in addition to the above, the tags can be applied by automated systems using predefined rules or machine learning algorithms that dynamically assess and assign tags based on user behavior, network conditions, or security policies.

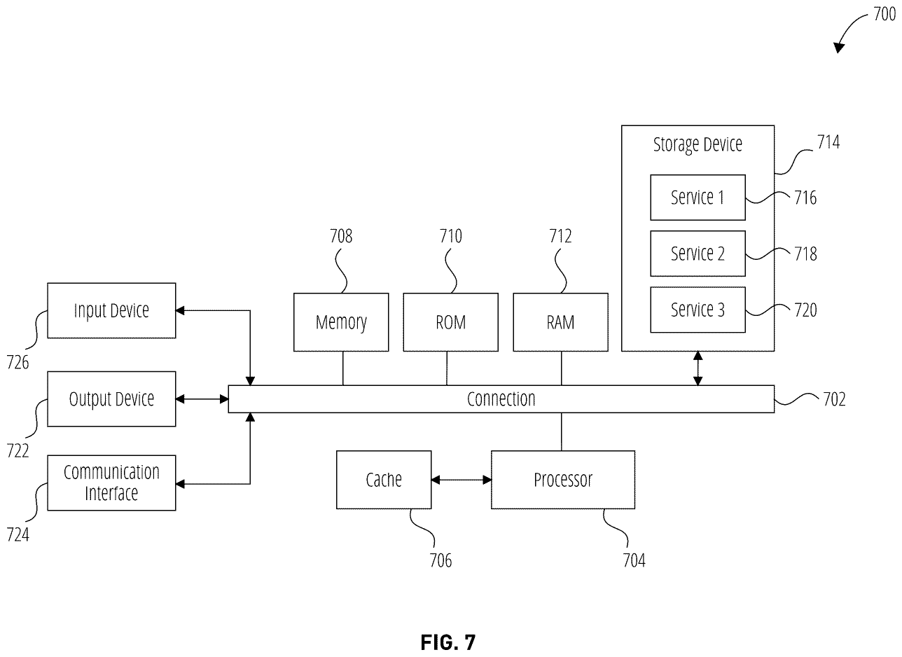

FIG. 7 shows an example of computing system 700, which can be for example any computing device making up a controller, for example a controller of an SDWAN network, or any component thereof in which the components of the system are in communication with each other using connection 702. Connection 702 can be a physical connection via a bus, or a direct connection into processor 704, such as in a chipset architecture. Connection 702 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) 704 and connection 702 that couples various system components including system memory 708, such as read-only memory (ROM) 710 and random access memory (RAM) 712 to processor 704. Computing system 700 can include a cache of high-speed memory 706 connected directly with, in close proximity to, or integrated as part of processor 704.

Processor 704 can include any general purpose processor and a hardware service or software service, such as services 716, 718, and 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the necessary hardware components, such as processor 704, connection 702, output device 722, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Aspect 1. A method comprising determining, by a network device, a group to which a user is associated; receiving a data packet; attaching a tag to a header of the data packet representing a user criticality score that quantifies a criticality of the group to which the user is associated; computing an overall criticality score based at least in part on the user criticality score; and determining whether to duplicate the data packet based on the overall criticality score.

Aspect 2. The method of Aspect 1, further comprising: inspecting the data packet to determine an application to which the data packet is associated; determining an application criticality score based on the application to which the data packet is associated; and computing the overall criticality score based at least in part on the user criticality score and the application criticality score.

Aspect 3. The method of Aspect 1, wherein determining whether to duplicate the data packet is performed by comparing the overall criticality score to a threshold score.

Aspect 4. The method of Aspect 3, further comprising receiving the threshold score from an administrator of a network.

Aspect 5. The method of Aspect 1, wherein the group to which the user is associated is determined by: authenticating the user; determining an internet protocol address (IP address) of the user; and determining the group to which the user is associated based on the IP address of the user.

Aspect 6. The method of Aspect 5, wherein the IP address is determined by retrieving the IP address from at least one of a dynamic host configuration protocol pool (DHCP pool) and static allocation.

Aspect 7. The method of Aspect 1, wherein determining whether to duplicate the data packet is performed by comparing the overall criticality score against a range of criticality scores, and duplicating the data packet only if the overall criticality score is within the range of criticality scores.

Aspect 8. A network device comprising: a storage configured to store instructions; and at least one processor configured to execute the instructions and cause the at least one processor to: determine a group to which a user is associated; receive a data packet; attach a tag to a header of the data packet representing a user criticality score that quantifies a criticality of the group to which the user is associated; compute an overall criticality score based at least in part on the user criticality score; and determine whether to duplicate the data packet based on the overall criticality score.

Aspect 9. The network device of Aspect 8, wherein the at least one processor is configured to execute the instructions and further cause the at least one processor to: inspect the data packet to determine an application to which the data packet is associated; determine an application criticality score based on the application to which the data packet is associated; and compute the overall criticality score based at least in part on the user criticality score and the application criticality score.

Aspect 10. The network device of Aspect 8, wherein the instructions to determine whether to duplicate the data packet is performed by comparing the overall criticality score against a threshold score.

Aspect 11. The network device of Aspect 10, wherein the at least one processor is configured to execute the instructions and further cause the at least one processor to receive the threshold score from an administrator of a network.

Aspect 12. The network device of Aspect 8, wherein the at least one processor is configured to execute the instructions and further cause the at least one processor to: authenticate the user; determine an IP address of the user; and determine the group to which the user is associated based on the IP address of the user.

Aspect 13. The network device of Aspect 12, wherein the IP address is determined by retrieving the IP address from at least one of a DHCP pool and static allocation.

Aspect 14. The network device of Aspect 8, wherein determining whether to duplicate the data packet is performed by comparing the overall criticality score against a range of criticality scores, and duplicating the data packet only if the overall criticality score is within the range of criticality scores.

Aspect 15. A non-transitory computer-readable storage medium including instructions that, when executed by at least one processor, cause the at least one processor to: determine a group to which a user is associated; receive a data packet; attach a tag to a header of the data packet representing a user criticality score that quantifies a criticality of the group to which the user is associated; compute an overall criticality score based at least in part on the user criticality score; and determine whether to duplicate the data packet based on the overall criticality score.

Aspect 16. The non-transitory computer-readable storage medium of Aspect 15, wherein the at least one processor is configured to execute the instructions and further cause the at least one processor to: inspect the data packet to determine an application to which the data packet is associated; determine an application criticality score based on the application to which the data packet is associated; and compute the overall criticality score based at least in part on the user criticality score and the application criticality score.

Aspect 17. The non-transitory computer-readable storage medium of Aspect 15, wherein the instructions to determine whether to duplicate the data packet is performed by comparing the overall criticality score against a threshold score.

Aspect 18. The non-transitory computer-readable storage medium of Aspect 17, wherein the at least one processor is configured to execute the instructions and further cause the at least one processor to receive the threshold score from an administrator of a network.

Aspect 19. The non-transitory computer-readable storage medium of Aspect 15, wherein the group to which the user is associated is determined by authenticating the user; determining an IP address of the user; and determining the group to which the user is associated based on the IP address of the user.

Aspect 20. The non-transitory computer-readable storage medium of Aspect 19, wherein the IP address is determined by retrieving the IP address from at least one of a DHCP pool and static allocation.

What is claimed is:

1. A method comprising:
determining, by a network device, a group to which a user is associated;
receiving a data packet;
attaching a tag to a header of the data packet representing a user criticality score that quantifies a criticality of the group to which the user is associated;
computing an overall criticality score based at least in part on the user criticality score; and
determining whether to duplicate the data packet based on the overall criticality score.

2. The method of claim 1, further comprising:
inspecting the data packet to determine an application to which the data packet is associated;
determining an application criticality score based on the application to which the data packet is associated; and
computing the overall criticality score based at least in part on the user criticality score and the application criticality score.

3. The method of claim 1, wherein determining whether to duplicate the data packet is performed by comparing the overall criticality score to a threshold score.

4. The method of claim 3, further comprising receiving the threshold score from an administrator of a network.

5. The method of claim 1, wherein the group to which the user is associated is determined by:
authenticating the user;
determining an internet protocol address (IP address) of the user; and
determining the group to which the user is associated based on the IP address of the user.

6. The method of claim 5, wherein the IP address is determined by retrieving the IP address from at least one of a dynamic host configuration protocol pool (DHCP pool) and static allocation.

7. The method of claim 1, wherein determining whether to duplicate the data packet is performed by comparing the overall criticality score against a range of criticality scores, and duplicating the data packet only if the overall criticality score is within the range of criticality scores.

8. A network device comprising:
a storage configured to store instructions; and
at least one processor configured to execute the instructions and cause the at least one processor to:
determine a group to which a user is associated;
receive a data packet;
attach a tag to a header of the data packet representing a user criticality score that quantifies a criticality of the group to which the user is associated;
compute an overall criticality score based at least in part on the user criticality score; and
determine whether to duplicate the data packet based on the overall criticality score.

9. The network device of claim 8, wherein the at least one processor is configured to execute the instructions and further cause the at least one processor to:
inspect the data packet to determine an application to which the data packet is associated;
determine an application criticality score based on the application to which the data packet is associated; and
compute the overall criticality score based at least in part on the user criticality score and the application criticality score.

10. The network device of claim 8, wherein the instructions to determine whether to duplicate the data packet is performed by comparing the overall criticality score against a threshold score.

11. The network device of claim 10, wherein the at least one processor is configured to execute the instructions and further cause the at least one processor to receive the threshold score from an administrator of a network.

12. The network device of claim 8, wherein the at least one processor is configured to execute the instructions and further cause the at least one processor to:
authenticate the user;
determine an IP address of the user; and
determine the group to which the user is associated based on the IP address of the user.

13. The network device of claim 12, wherein the IP address is determined by retrieving the IP address from at least one of a DHCP pool and static allocation.

14. The network device of claim 8, wherein determining whether to duplicate the data packet is performed by comparing the overall criticality score against a range of criticality scores, and duplicating the data packet only if the overall criticality score is within the range of criticality scores.

15. A non-transitory computer-readable storage medium including instructions that, when executed by at least one processor, cause the at least one processor to:
determine a group to which a user is associated;
receive a data packet;
attach a tag to a header of the data packet representing a user criticality score that quantifies a criticality of the group to which the user is associated;
compute an overall criticality score based at least in part on the user criticality score; and
determine whether to duplicate the data packet based on the overall criticality score.

16. The non-transitory computer-readable storage medium of claim 15, wherein the at least one processor is configured to execute the instructions and further cause the at least one processor to:
inspect the data packet to determine an application to which the data packet is associated;
determine an application criticality score based on the application to which the data packet is associated; and
compute the overall criticality score based at least in part on the user criticality score and the application criticality score.

17. The non-transitory computer-readable storage medium of claim 15, wherein the instructions to determine whether to duplicate the data packet is performed by comparing the overall criticality score against a threshold score.

18. The non-transitory computer-readable storage medium of claim 17, wherein the at least one processor is configured to execute the instructions and further cause the at least one processor to receive the threshold score from an administrator of a network.

19. The non-transitory computer-readable storage medium of claim 15, wherein the group to which the user is associated is determined by:
authenticating the user;
determining an IP address of the user; and
determining the group to which the user is associated based on the IP address of the user.

20. The non-transitory computer-readable storage medium of claim 19, wherein the IP address is determined by retrieving the IP address from at least one of a DHCP pool and static allocation.
